(19) United States
(12) Patent Application Publication
(10) Pub. No.: US 2023/0083164 A1
(43) Pub. Date: Mar. 16, 2023

(54) POLYLACTIC ACID FLAME RESISTANT BLEND

(71) Applicant: FLOREON-TRANSFORMING PACKAGING LTD, Hessle (GB)

(72) Inventor: Andrew GILL, Hessle (GB)

(21) Appl. No.: 17/793,227

(22) PCT Filed: Jan. 15, 2021
(86) PCT No.: PCT/GB2021/050094

§ 371 Date: Jul. 15, 2022

(30) Foreign Application Priority Data
Jan. 16, 2020 (GB) 2000678.9

(51) Int. Cl. C08L 67/04

(52) U.S. Cl. CPC C08L 67/04

(57) ABSTRACT

A PLA containing blend having an impact strength and/or flow rate modifier in addition to a flame retardant. The blend is capable of achieving UL94 fire resistance as V0 certification.

### FIELD OF INVENTION

The present invention relates to a flame resistant blend and in particular, although not exclusively, to a polylactic acid based blend having a flame retardant component.

### BACKGROUND

Polylactic acid (PLA) is a recyclable and compostable plant-based plastic produced from annually renewable resources such as corn and sugar cane. The ultimate feedstock for producing PLA is atmospheric carbon dioxide, which is absorbed by plants and converted to sugars. These may be fermented to make the monomer lactic acid and polymerised through a number of steps to make high molecular weight polylactic acid. The consumption and sequestration of carbon dioxide by PLA therefore results in production pathways having a much reduced overall carbon footprint relative to those of established plastics which are typically made from fossil fuel derived carbon.

Whilst PLA exhibits a favourable eco-profile and has generally well-rounded mechanical properties (particularly high tensile strength and modulus), its use to make desirable products e.g., electronics components and casings has been limited by its resistance-to-burning characteristics. Accordingly, there is a need for a PLA based material offering enhanced resistance to burning whilst also satisfying the various other physical and mechanical characteristics required of a processable and mouldable plastic.

### SUMMARY OF THE INVENTION

It is an objective of the present invention to provide a PLA based material having flame resistant characteristics that is capable of processing by exclusion, moulding and the like in the manufacture of plastic articles, devices, packaging etc.

It is a further specific objective to provide a PLA based material having flame retardant characteristics and desired impact strength. It is a specific objective to provide a flame resistant PLA based material having a desired melt viscosity. It is a further specific objective to provide a PLA based material that is self-extinguishing and exhibits no burning dripping when tested according to standard fire tests for plastic materials such as UL94 (‘Standard for tests for flammability of plastic materials for parts in devices and appliances’) to achieve a V0 rating. It is a specific objective to provide a flame resistant PLA based material capable of manufacture via conventional moulding and extrusion methods.

Accordingly, in one aspect of the present invention there is provided a flame resistant blend comprising: polylactic acid (PLA); an impact strength and/or flow rate modifier selected from any one or a combination of polybutylene adipate-co-terephthalate (PBAT), polybutylene terephthalate (PBT), polybutylene succinate (PBS), polybutylene succinate-co-adipate (PBSA), polyhydroxyalkanoate (PHA), polycaprolactone (PCL), and a thermoplastic elastomer; and a flame retardant.

Optionally, the blend comprises the PLA at not less than 50 wt %; 55 wt %; 60 wt %; 65 wt %; 70 wt %; or wherein the PLA is included at 40 to 80 wt %; 50 to 70 wt %; 55 to 65 wt %; 28 to 86 wt %; 43.5 to 73.5 wt % or 45.5 to 71.5 wt %.

Optionally, the flame retardant may comprise an organohalogen; and/or an organophosphate. Optionally, the flame retardant may comprise a mineral based material and/or ammonium polyphosphate. Optionally, the mineral based material may comprise a magnesium carbonate mineral, such as hydromagnesite and/or a carbonate mineral such as huntite. Optionally, the mineral based material may comprise an anhydrous carbonate mineral or a calcium magnesium carbonate such as dolomite (dolostone).

Optionally, the flame retardant may comprise any one or a combination of: aluminium diethylene phosphonate; aluminium hydroxide; magnesium hydroxide; melamine polyphosphate; dihydrooxaphosphaphenanthrene; zinc stannate; zinc hydroxystannate.

Preferably, the flame retardant component is an intumescent capable of decomposition and/or reaction with other components of the blend such as polylactic acid, on exposure to flame, to form an insulating layer and prevent further burning. Preferably, the flame retardant comprises ammonium polyphosphate (APP). It has been identified that incorporation of a flame retardant within a PLA blend may in certain implementations increase or promote degradation of PLA (also known as chain scission) that in turn reduces impact strength and melt viscosity which can cause difficulties in processing, prevent recycling and increases a likelihood of burning dripping when testing under UL94. Accordingly, the present blend comprises an impact strength and/or flow rate modifier. Such modifiers are effective to increase the impact strength without compromising resistance to burning dripping during UL94 testing. Accordingly, the present blend comprises an impact strength and/or a flow rate modifier in combination with a flame retardant (as part of a PLA blend). The present blend is self-extinguishing to provide UL94-V0 certification (no burning dripping) and is convenient to process via conventional moulding (i.e. injection moulding) and/or extrusion processes. The present blend also comprises desired melt stability in addition to impact properties equal to or better than unmodified or raw/source PLA.

Optionally, the flame retardant component within the blend may be present at wt % 15 to 35; 15 to 30; 8 to 35; 15 to 25; 10 to 30 or 18 to 22.

Optionally, the impact strength and/or flow rate modifier may be included at wt % 5 to 40; 5 to 25; 8 to 20 or 8 to 18.

Preferably, the impact strength and/or flow rate modifier comprises PBAT, PCL, or a polyether block amide (PEBA).

Optionally, the blend may further comprise a nucleating agent. Optionally, the nucleating agent may comprise any one or a combination of talc; poly (D-lactic acid) also termed poly-DL-lactide; ethylene bis-stearamide (EBS); an aromatic sulfone derivative; mineral based particles or an organic nucleating agent. Advantageously, the nucleating agent improves heat resistance of the blend through crystallisation whilst also proving a contribution to the heat resistant characteristics. Optionally, the nucleating agent may be included at wt % 0.1 to 25; 0.1 to 20; 0.1 to 10; 0.1 to 5 or 1 to 15 or at 1-9 wt %; 1.5-8.5 wt %; 2-8 wt % or 4-8 wt %.

Optionally, the blend may further comprise a melt strength and stability modifier. Preferably, the melt strength and stability modifier comprises an acrylic based material being an oligomeric chain extender. Optionally, the melt strength and stability modifier is included at wt % 0.1 to 5; 0.1 to 3.5; 1 to 4 or 1.5 to 3.5. Such a modifier is advantageous during the melt processing including in particular extrusion and injection moulding. The modifier may also be advantageous to enhance wet and dry adhesion of the blend in addition to increasing water, corrosion and/or chemical resistance. The melt strength and stability modifier is also beneficial to provide enhanced final product/article durability and hardness.

Optionally, the blend may comprise a processing aid such as a surface friction reducing component. Such an additive is configured to reduce scuffing and scratching, improve packing and de-nesting of final articles as well as to facilitate processing via moulding and extrusion. Processing aids may comprise waxes, lubricants and the like, commonly used with PLA or other plastic based blends. An example processing aid includes Incromax™ 100 (Croda International plc, Goole, UK). Optionally, the processing aids may be included at wt % 0.1 to 1.0.

Optionally, the blend may further comprise at least one a reinforcing filler. Optionally, the reinforcing filler may comprise any one or a combination of: a mineral based filler, calcium carbonate, talc, glass fibers, a silicate, a calcium inosilicate material. Optionally, the reinforcing filler may be included at wt % 1 to 30 wt %; 2 to 25 wt %; 2 to 20 wt % or 5 to 20 wt %. Such reinforcing fillers may provide rigidity and creep resistance. Additionally, such additives may reinforce the material against sagging due to high temperatures. Optionally, the reinforcing filler may comprise wollastonite.

Preferably, the PLA blend comprises APP and/or a melamine encapsulated APP; and/or a polyether block amide (PEBA), PBAT or PBAT and PCL.

Optionally, the thermoplastic elastomer is any one or a combination of: a styrenic block copolymer; a polyolefin elastomer; a vulcanizate; a polyurethane; a copolyester; a polyamide; a polyether block amide (PEBA); nylon.

Preferably, the blend comprises poly-DL-lactide (PLA); a thermoplastic elastomer being preferably a polyether block amide (PEBA); a nucleating agent being preferably poly-D-lactide; a flame retardant and optionally a chain extender.

Optionally, the blend comprises poly-DL-lactide at 28 to 80 wt %; 43.5 to 73.5 wt % or 45.5 to 71.5 wt %. Preferably, the blend comprises the thermoplastic elastomer (polyether block amide) at 5 to 25 wt %; 8 to 20 wt % or 8 to 18 wt %. Preferably, the blend comprises the poly-D-lactide at 0.5 to 10 wt %; 2 to 8 wt % or 4 to 8 wt %. Preferably, the blend comprises the flame retardant at 8 to 32 wt %; 10 to 30 wt % or 15 to 25 wt %. Optionally, the blend comprises the chain extender at 0.5 to 5 wt %; 1 to 4 wt % or 1.5 to 3.5 wt %.

Optionally, the blend comprises the thermoplastic elastomer, the nucleating agent, the flame retardant and optionally the chain extender at the respective concentrations referred to herein in addition to poly-DL-lactide (PLA) at balance wt %. Preferably, the balance wt % may be anywhere in the range 58 to 88 wt % or more preferably 58 to 62 wt %.

Preferably, the present blend comprises the thermoplastic elastomer with a renewable carbon content of over 70%, 80%, or 90% and/or a biobased, renewable or recyclable content of over 70%, 80%, or 90%. Preferably, a majority wt % of the present blend is formed from or comprises biodegradable components. Optionally, a minority wt % component of the present blend is non-degradable. Optionally the only component of the present blend that is non-degradable is the thermoplastic elastomer.

Preferably, the poly-DL-lactide is be the majority wt % component within the blend. Reference to the majority wt % component encompasses a mass/weight amount of poly-DL-lactide relative to a mass/weight of any other component present within the blend.

According to a further aspect of present invention there is provided a flame retardant composition comprising: a blend as claimed and described herein; and any one of or a combination of: a filler; a compatibilizer; a processing aid.

Preferably the filler comprises any one or a combination of: a mineral based filler, calcium carbonate, talc, glass fibers, a silicate, a calcium inosilicate material.

According to a further aspect of the present invention there is provided an article comprising the blend or composition as claimed or described herein. Optionally, the article may be a plug; a bottle; a container for food stuffs; a packaging article; an extruded profile; a casing for an electronics device; or a laptop, electronics tablet or smartphone casing.

According to a further aspect of the present invention there is provided a method of manufacturing a blend comprising: preparing a material batch from starting materials comprising: polylactic acid; an impact strength and/or flow rate modifier selected from any one or a combination of polybutylene adipate-co-terephthalate (PBAT), polybutylene terephthalate (PBT), polybutylene succinate (PBS), polybutylene succinate-co-adipate (PBSA), polyhydroxyalkanoate (PHA), polycaprolactone (PCL), and a thermoplastic elastomer; and a flame retardant; heating the material batch to form a heated melt; and cooling the heated melt to form the blend.

Optionally, the step of heating comprises heating at a temperature in a range 150 to 230° C. Optionally, the step of heating comprises passing the material batch through an extruder to form an extruded strand; and the step of cooling comprises passing the extruded strand into a water bath.

Preferably, the method comprises blending the material batch prior to heating the material.

According to a further aspect of the present invention there is provided a flame resistant blend manufactured by the method as claimed and described herein.

According to a further aspect of the present invention there is provided a method of polymer processing to create a plastic product comprising the steps of processing the polymer blend or polymer composition as claimed and described herein by any one or a combination of: extrusion; injection moulding; blow moulding; thermoforming.

According to a further aspect of the present invention there is provided a method of manufacturing an article comprising: placing the blend obtained from the method as described and claimed herein into a mould; heating the mould and/or the blend; and cooling the blend to obtain the article.

According to a further aspect of the present invention there is provided a method of manufacturing an article comprising: placing the blend obtained from the method as described and claimed herein into an extruder; extruding the blend through a die to form a profile; and cooling the blend to obtain the article.

According to a further aspect of the present invention there is provided a method of manufacturing an article by polymer processing as claimed and described herein further comprising: annealing the plastic product or article after the step of forming, moulding or extruding.

Optionally, the step of annealing comprises heating the plastic product or article at a temperature in the range 50° C. to 140° C. or 60° C. to 130° C. to induce crystallinity.

In one preferred implementation, the present blend may comprise 55 to 59 wt % PLA; 18 to 22 wt % PBAT and 20 to 24 wt % APP or an APP derivative such as melamine encapsulated APP (where the melamine may be considered to assist dispersion). In one preferred implementation, the present blend may comprise 58 to 62 wt % PLA; 10 to 14 wt % PEBA, 18 to 22 wt % flame retardant and optionally 0.5 to 4 wt % of a chain extender. Optionally the flame retardant is APP or an APP derivative such as melamine encapsulated APP and/or the chain extender is an epoxidized styrene-acrylic copolymer (CESA-Extend™ (in the form of a masterbatch from Clariant Masterbatches). In such embodiments any balance may be PLA. Optionally the present blend consists of 58 to 62 wt % PLA; 10 to 14 wt % PEBA, 18 to 22 wt % flame retardant and optionally 0.5 to 4 wt % of a chain extender. Optionally the PLA may be Luminy™ L105 (as supplied by Total-Corbion™, Gorinchem, The Netherlands); the PBAT may be Kingfa™ A400 (as supplied by Guangzhou, China) and the APP may be Exolit™ AP 462 (as supplied by Clariant™, Muttenz, Switzerland).

Optionally, where the present blend comprises PBT or PBAT, this is included at between 1 to 40 wt %. Optionally, PBT or PBAT may be included at between 20 to 40 wt % but could be used at much higher levels, up to 60 wt % and much lower levels approaching 1 wt %.

### DETAILED DESCRIPTION OF PREFERRED EMBODIMENT OF THE INVENTION

Blends incorporating PLA, an impact strength and/or flow rate modifier and a flame retardant were prepared. Flammability and fire resistance of different blend compositions was tested according to UL94 — Standard for Tests for Flammability of Plastic Materials for Parts in Devices and Appliances.

### EXAMPLES

### Blend Preparation

A variety of PLA based blends were prepared as shown in table 1

TABLE 1
PLA based blends 1 to 6 as prepared for testing.

| | Composition in wt % | | | | |
|---|---|---|---|---|---|
| | | | | Flame retardant | Mineral-based |
| | PLA/ | PBAT/ | PCL/ | APP/ | flame retardant |
| Examples | (Luminy ™ L105) | (Kingfa ™ A400) | (Capa ™ 6250) | (Exolit ™ AP462) | (Ultracarb ™ LH15) |
| Blend 1 | 100 | — | — | — | — |
| Blend 2 | 57.5 | 20 | — | 22.5 | — |
| Blend 3 | 57.5 | 15 | 5 | 22.5 | — |
| Blend 4 | 40 | 20 | — | — | 40 |
| Blend 5 | 25 | 20 | 15 | — | 40 |
| Blend 6 | 80 | 20 | — | — | — |

Injection moulding grade PLA with high optical purity (Luminy™ L105, as supplied by Total-Corbion™) was used as the base material and two different flame retardants (Exolit™ AP462, a micronized APP based flame retardant encapsulated in melamine as supplied by Clariant™, Muttenz, Switzerland and Ultracarb™ LH15, a finely milled mixture of hydromagnesite and huntite as supplied by LKAB Minerals™, Luteå, Sweden) were added. To these mixtures, PBAT (Kingfa™ A400—a high molecular weight extrusion grade of PBAT) and Capa™ 6250 (a low molecular weight polycaprolactone) (as supplied by Perstorp, Malmō, Sweden) were added in different amounts to control physical properties and aid ‘wetting out’ and dispersion of the materials in the melt. PLA (Luminy™ L105) was used without compounding to provide a comparison of burn behaviour and mechanical properties.

All test materials (Blends 1-6) were produced using a twin-screw extruder. An APV 19 mm twin screw extruder with L:D ratio of 25:1 was used and the materials were dried under vacuum for 24 hrs at 60° C., with the exception of PCL (when used) which was used as supplied. All materials were dry blended and fed directly into the hopper at a constant rate using a volumetric feeder. A typical temperature profile of 175° C. in the feed section and 180° C. in the subsequent mixing zones and die was used, with minor modifications depending on the specific mixture according to throughput, torque and strand stability as needed. The strand was passed through a cooling water bath before passing through an air knife do drive-off water and pelletised for further processing.

### Fire and Mechanical Testing

To compare the mechanical properties and fire resistance of the materials test specimens were again dried for 24 hrs at 60° C. and then moulded using a Fanuc s-200i 100 A injection moulding machine using the settings shown in Table 2.

For UL-94, Limiting oxygen index (LOI) and mechanical testing (standard tensile testing) pieces with dimensions of 80×4×10 mm were prepared in the gauge section according to ISO 178 unless otherwise indicated.

TABLE 2
Injection Moulding Conditions for Test Pieces

| Injection settings | | | Extrusion settings | | | Temperature settings | |
|---|---|---|---|---|---|---|---|
| Injection speed | 120 | (mm/s) | Back pressure | 60 | (bar) | Feed zone | 35° C. |
| Position transfer | 10 | (mm) | Speed | 120 | rpm | Zone 1 | 160° C. |
| Pack pressure | 500 | (bar) | DCMP distance | 5 | (mm) | Zone 2 | 170° C. |
| Packing time | 15 | (sec) | DCMP velocity | 5 | (mm/s) | Zone3 | 170° C. |
| Shot size | 46 | (mm) | Cool time | 25 | (sec) | Zone 4 | 180 |
| | | | | | | nozzle | 190° C. |

To compare the flammability and fire resistance, moulded test pieces as described were tested for their rating using the UL94-V test method. In summary, test specimens of each material were suspended vertically from a top edge and a 10 mm burner flame was applied at 45° and at a distance of 5 mm below a bottom edge for 10 seconds. The burner was then removed, and the duration of any burning measured. When a sample self-extinguished, the burner was reapplied immediately for a further 10 seconds and removed, with the duration of any burning recorded again. Five replicate samples were tested and the total of the ten exposures used to assign the rating against a number of set criteria, these being UL-94 V0 (combustion time of any specimen being less than 10 seconds, total burn time for all samples being less than 50 seconds, no burning dripping), 94V-1, 94V-2 and finally ‘not classifiable’.

LOI is a test that determines the minimum oxygen concentration necessary to sustain burning of a test material. The higher above the typical atmospheric concentration of oxygen (21%), the more difficult it is to sustain burning of the material giving a quantitative comparison of the fire resistance of a material. Bars of the dimensions described in the methods section were tested according to ISO 4589-2. Samples were supported in a standard holder in the test chamber and ignited with gradual increase in oxygen content of the test gas mixture until burning was self-supporting to determine the minimum amount of oxygen needed to support ignition.

To determine the tensile and impact properties of the materials, samples were aged for 7 days at ambient temperature and humidity before analysis. A Messphysik BETA 20- 10/8×15 tensile test machine with maximum load capacity of 20 kN and a Pixelink Monochrome camera (3.1 megapixels and 95 fps) for the video extensometer data were used to evaluate tensile behaviour.

An Instron Dynatup POE 2000 pendulum impact test machine was used for the IZOD impact testing, where the injection moulded samples were notched in the middle of the gauge section. For all the mechanical characterisation techniques five specimens were tested for each blend (1 to 6).

### Performance Results

Results of UL94 and LOI testing on Blends 1 to 6 are shown in Tables 3 and 4 respectively. It can be seen from the presented results that PLA, PLA and PBAT as a binary mixture and mixtures containing the LH15 flame retardant were not classifiable, resulting in a ‘fail’ for these materials. Conversely, both blends containing Exolit™ have achieved a UL94-VO rating and a significantly elevated LOI rating indicating a high level of fire resistance. It should be noted that LOI testing is usually performed on test specimens at a thickness of 1.6 mm, rather than at 4 mm as tested. It is not anticipated that this would affect the results of the test significantly and the results of the trend provide a useful comparison between the different materials in agreement with the results of the UL94 testing.

TABLE 3
Results of UL94 testing of the prepared blends.

| | Total Burn | Specimen Fully | Flaming Drips | |
|---|---|---|---|---|
| Material | Time (s) | Burnt (Y/N) | (Y/N) | Classification |
| Blend 1 | 180+ | N | Y | Fail |
| Blend 2 | 0 | N | N | 94V-0 |
| Blend 3 | 9 | N | N | 94V-0 |
| Blend 4 | 155+ | N | N | Fail |
| Blend 5 | 150+ | N | N | Fail |
| Blend 6 | 150+ | N | Y | Fail |

TABLE 4
LOI ratings for the prepared materials.

| Material | LOI |
|---|---|
| Blend 1 | 23.5 |
| Blend 2 | 30.5 |
| Blend 3 | 30 |
| Blend 4 | 24.5 |
| Blend 5 | 22 |
| Blend 6 | 23.5 |

From tensile and impact strength results shown in Table 5 it can also be observed that the impact strength of all materials, even those containing flame retardants exhibit increased impact strength in comparison with pure PLA. Impact strength of the PLA/PBAT/APP blend is increased further by the addition of PCL, which appears slightly detrimental to fire resistance as observed by the increased burn times of these samples. However, the effect is not severe enough to compromise the UL94-V0 rating. It can be seen from the tensile data that PBAT in particular decreases the tensile or elastic modulus and strength of the PLA, whilst generally increasing strain at break. As PLA is a material with high strength and modulus, this is not a particular concern for the blends produced and indicates a slightly more ductile product. It can also be observed that strain at break decreases in PLA/PBAT mixtures on the addition of APP. This is probably due to slight degradation of the PLA induced by the APP or poor compatibility between the APP and PLA matrix. However, this still presents a material with balanced tensile strength, modulus, impact strength and elastic modulus.

TABLE 5
Tensile and Impact Properties of the Developed Blends. Values are
the mean average of five repeats (standard deviation not shown).

| | Elastic | Tensile | Elongation | Impact |
|---|---|---|---|---|
| | Modulus | Strength | at Break | Strength |
| Material | (GPa) | (MPa) | (%) | (kJ/m²) |
| Blend 1 | 2.14 | 70.62 | 4.65 | 1.63 |
| Blend 2 | 1.67 | 36.47 | 3.65 | 1.71 |
| Blend 3 | 1.68 | 35.28 | 5.49 | 1.93 |
| Blend 4 | 1.75 | 33.36 | 6.56 | 2.38 |
| Blend 5 | 1.09 | 25.87 | 8.76 | 2.65 |
| Blend 6 | 1.61 | 51.48 | 12.56 | 1.83 |

### Further Blends

Various further blends were prepared and tested consistent with the preparation and methods described above relating to blends 1 to 6.

Blend 7: contained a high molecular weight and optical purity injection moulding grade of PLA (Ingeo 3260HP) at an addition level of 45.5% by weight, Ultracarb™ LH15 at 30%, combined with Capa™ 6500 (a high molecular weight grade of polycaprolactone) to provide toughness and easy dispersion of the Ultracarb™) at 21% and BioPBS FZ91PD (a high molecular weight extrusion grade of polybutylene succinate, commonly added to PLA to improve ductility) at 3.5%. prepared using a commercial compounding line using a profile similar to that presented in the methods.

Blend 8: contained a high molecular weight and optical purity injection moulding grade of PLA (Ingeo 3260HP) at an addition level of 42% by weight, Ultracarb™ LH15 at 40%, combined with Capa™ 6500 (a high molecular weight grade of polycaprolactone) to provide toughness and easy dispersion of the Ultracarb™) at 18% and BioPBS FZ91PD (a high molecular weight extrusion grade of polybutylene succinate, commonly added to PLA to improve ductility) at 3%. prepared using a commercial compounding line using a profile similar to that presented in the methods.

Both materials were moulded as described to produce standard test pieces and tested to determine their UL94 rating and impact strength. The impact strength of the materials was comparable and within the range of Blends 1 to 6. However only UL94-V1 rating could be achieved due to excessive times of combustion (total burn time 17.0 and 11.8). No dripping was experienced.

Blend 9: contained Exolit™ as the flame retardant species, as an alternative to Ultracarb™ LH15. The content of PCL was reduced compared to blends 7 and 8 as PCL is a waxy substance with a low melting point and may increase burning. A fine talc was also added to stabilise char formation and provide resin dilution. To compensate for the reduced amount of PCL, a commercial impact modifier (Biostrength 282) was added to the formulation to provide impact strength.

The specific formulation of blend 9 was: Ingeo 3260HP at 55% by weight, Exolit™ AP462 (20% by weight), Capa™ 6500 at 5% by weight, BioPBS FZ91PD at 5% by weight, Biostrength 282 at 10% and Finntalc MO5SL at 5% by weight.

Blend 10: contained Ultracarb™ LH15 as the flame retardant with a slightly reduced PCL content, and the addition of further Biostrength 282 and talc, with the aim of making the slight reduction in burn times needed whilst maintaining impact strength. The final formulation was: Ingeo 3260HP at 37.5% by weight, Ultracarb™ LH15 at 40%, Capa™ 6500 at 15%, BioPBS at 1%, Biostrength 282 at 6% and Finntalc MO5SL at 0.5%.

Due to the addition of a standard acrylic impact modifier commonly used with PLA, both materials showed significantly higher impact strength than Blends 1 to 6, being 3.43 kJ/m² and 3.08 kJ/m² respectively. The burn times of the materials were 6.4 and 35 seconds respectively, in isolation making the Blend 9 certifiable to UL94-V0. However, both blends exhibited strong burning dripping preventing UL94-V0 being achieved.

### Further Blends

A series of further formulations were prepared with the aim of maximising impact performance and heat resistance. In a first round of testing, three compounds were produced combining PLA (Ingeo 3260HP, a high optical purity injection grade of PLA similar in properties and characteristics to Luminy L105) as the major component and selected non-degradable elastomers as an impact modifier. A further compound was produced containing a selected non-degradable elastomer and a nucleating agent (DPLA). This compound was then modified further through the addition of a selected flame retardant to achieve a flame retarded product. The results are summarised in Table 6. Blends 11 to 14 are comparative and did not contain a flame retardant component.

### Materials Used

For blends 11 to 15, the further development was undertaken using Ingeo™ 3260HP (from NatureWorks LLC), a high optical purity grade of poly-L-lactic acid for injection moulding which is designed to crystallise when processed appropriately. As a nucleating agent, Luminy™ D070 (Total Corbion PLA), a grade of poly-D-lactic acid with an optical purity of 99.5% by weight was used. As an elastomeric degradable impact modifier, PBAT (polybutylene adipate-co-terephthalate, grade Kingfa™ A400) was used and PEBAX™ 2533 SA01, available from Arkema Inc., (a polyether block amide, also referred to as PEBA) was used as a non-degradable modifier. Dryflex Green™ OFB 52224 N (a thermoplastic elastomer with a renewable carbon content of 81%), Dryflex Green™ SC 52273 N (a thermoplastic elastomer with a biobased content of 82%) both from HEXPOL TPE GmbH or Greenflex™ ML50 from (an ethylene vinyl-acetate copolymer) were used as a non-degradable elastomeric modifier (from Versalis S.p.A).

TABLE 6
Blends 11 to 15 incorporating a non-degradable elastomer.

| | | PEBAX ® | Dryflex | Dryflex | | |
|---|---|---|---|---|---|---|
| | Ingeo | 2533 | Green OFB | Green SC | Luminy | Exolit |
| Material | 3260HP | SA01 | 52224 N | 52273 N | D070 | AP462 |
| Blend 11 | 85 | 15 | | | | |
| (comparative) | | | | | | |
| Blend 12 | 85 | | 15 | | | |
| (comparative) | | | | | | |
| Blend 13 | 85 | | | 15 | | |
| (comparative) | | | | | | |
| Blend 14 | 79 | 15 | | | 6 | |
| (comparative) | | | | | | |
| Blend 15 | 60.75 | 12 | | | 4.75 | 22.5 |

### Performance Results of Non-Degradable Blends

The impact, modulus and fire resistance of the test formulations was measured where appropriate and compared to previous results. The results are shown in Table 7. The addition of non-degradable elastomers to PLA in all cases led to an increase in impact resistance, and in particular when combined with DPLA when used as a nucleating agent. The combination of DPLA with PLA at addition levels of up to 15% is understood and is associated with no significant improvement in impact strength. The present results therefore provide evidence of a surprising synergy of the combination of PEBAX and DPLA. The addition of a flame retardant to this material does cause a drop in impact performance and strength (understood to be the result of a lack of compatibility between the Exolit particles and the PLA matrix). However, a higher level of impact resistance relative to the earlier blends 1 to 6 (incorporating PBAT) is still achieved.

TABLE 7
Blends 11 to 15 incorporating a non-degradable elastomer.
Impact strength and modulus of non-degradable elastomer
modified blends. Results are mean average of 10 repeats
(impact) and 5 repeats (modulus).

| | Impact Strength | Tensile Modulus | UL94-V |
|---|---|---|---|
| Material | (kJ/m2) | (GPa) | Rating |
| Blend 11 | 7.41 | 1.51 | Not measured. |
| (comparative) | | | |
| Blend 12 | 4.94 | 1.70 | Not measured. |
| (comparative) | | | |
| Blend 13 | 10.73 | 1.47 | Not measured. |
| (comparative) | | | |
| Blend 14 | 17.43 | 1.49 | Not measured. |
| (comparative) | | | |
| Blend 15 | 5.03 | 1.37 | V0 |

### Further Optimised Blends

A further round of formulations was then prepared incorporating a slightly reduced quantity of flame retardant and a chain extender, intended to prevent any degradation of the polymer induced by the addition of the flame retardant. The formulations tested (Blends 16 to 19) are detailed in Table 8. A further formulation containing PLA, DPLA and an elastomeric material (Greenflex ML50, being an ethylene vinyl-acetate copolymer) was also evaluated with and without flame retardant to compare impact performance. Compounding with EVA has been reported as an effective method of increasing the impact resistance of PLA. A combination of PLA, DPLA and PEBAX was also produced using a higher molecular weight grade of DPLA (Luminy D120) in order to confirm whether this material had similar properties to the blend encompassing Luminy D070.

TABLE 8
Further blends 16 to 19 as tested.

| | | PEBAX ® | | | | | |
|---|---|---|---|---|---|---|---|
| | Ingeo | 2533 | Luminy | Exolit | Luminy | Greenflex | CESA- |
| Material | 3260HP | SA01 | D120 | AP462 | D070 | ML50 | Extend |
| Blend 16 | 60 | 12 | 5.5 | 20 | | | 2.5 |
| Blend 17 | 78 | | 7 | | | 15 | |
| (comparative) | | | | | | | |
| Blend 18 | 60.5 | | 5.5 | 22.5 | | 11.5 | |
| Blend 19 | 79 | 15 | 6 | | | | |
| (comparative) | | | | | | | |

### Performance Results of Further Optimised Blends

It was found that on reducing the flame retardant from 22.5% to 20% and the addition of a chain extender masterbatch (CESA-Extend™) UL94-V0 fire resistance could be maintained, and a higher level of impact resistance achieved. It was also determined that compounding with EVA gave a slight increase in impact strength over unmodified PLA with and without a flame retardant, but this was not comparable to that achieved with blends incorporating PEBA and DPLA. It was also found that the blend incorporating Luminy D120 had similar performance to that of the earlier blend incorporating Luminy D070. Impact strength and fire resistance results are presented in Table 9.

TABLE 9
Impact and fire resistance data of tested blends
16 to 19. Impact data average of 10 repeats. Blend
19 was tested to ISO 180 (interchangeable with
ASTM D256) due to equipment availability.

| | Impact Strength | UL94-V |
|---|---|---|
| Material | (kJ/m2) | Rating |
| Blend 16 | 6.52 | V0 |
| Blend 17 (comparative) | 4.73 | Not Measured. |
| Blend 18 | 3.98 | Not Measured. |
| Blend 19 (comparative) | 17* | Not Measured. |

Samples of Blend 19 were also moulded and laid flat on metal tray within an air circulating oven at 80° C. for 2 hours before being tested again for impact resistance after acclimatising at ambient for 48 hours. Heating the material in this way is known to induce crystallinity in PLA, leading to an increased heat deflection temperature typically of around 150° C. based on the performance of the PLA matrix. On re-testing the impact resistance of the Blend 19, the impact resistance was found to have increased to 20.45 kJ/m² and the samples began to bend during testing without breaking completely, indicating changed fracture mechanics and a more ductile material.

According to the above preparations and testing, PLA based blends with good mechanical properties and favourable flame resistance have been successfully achieved. The present blends may be used as or within fire resistant thermoplastic materials (i.e. moulded products) for a range of applications including electronics casings, (e.g., plugs for telephone chargers), plastic casings and components of portable power banks and batteries, electronic toothbrushes, laptop and computer casings and computer components, electronic toothbrushes, plastic components of consumer electronics devices such as speakers, fridges, televisions, coffee makers, and components for automotive interiors.

The present blends may be used for the manufacture of extruded products, particularly profile extrusions for use in home furnishings, mobile caravans, window frames, automotive panels, end caps and joining sections between PVC wall sections, extruded PVC wall sections, decorative panels. The present blends may be used in 3D printing manufacture and additive manufacturing.

Unless defined otherwise all technical and scientific terms used herein have the same meaning as commonly understood to one of ordinary skill in the art to which the presently described subject matter pertains.

Unless otherwise indicated, any reference to “wt %” refers to the mass fraction of the component relative to the total mass of the cemented carbide.

Where a range of values is provided, for example, concentration ranges, percentage range or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

It should be understood that the terms “a” and “an” as used above and elsewhere herein refer to “one or more” of the enumerated components. It will be clear to one of ordinary skill in the art that the use of the singular includes the plural unless specifically stated otherwise. Therefore, the terms “a”, “an” and “at least one” are used interchangeably in this application.

Unless otherwise indicated, all numbers expressing quantities of ingredients, properties such as size, weight, reaction conditions and so forth used in the specification and claims are to be understood as being modified in all instances by the term “about”. Accordingly, unless indicated to the contrary, the numerical parameters set forth in the following specification and attached claims are approximations that may vary depending upon the desired properties sought to be obtained by the present subject matter. At the very least, and not as an attempt to limit the application of the doctrine of equivalents to the scope of the claims, each numerical parameter should at least be construed in light of the number of reported significant digits and by applying ordinary rounding techniques.

Throughout the application, descriptions of various embodiments use “comprising” language; however, it will be understood by one of skill in the art that, in some instances, an embodiment can alternatively be described using the language “consisting essentially of” or “consisting of”.

The present subject matter being thus described, it will be apparent that the same may be modified or varied in many ways. Such modifications and variations are not to be regarded as a departure from the spirit and scope of the present subject matter, and all such modifications and variations are intended to be included within the scope of the following claims.

1. A flame resistant blend comprising:
polylactic acid (PLA);
an impact strength and/or flow rate modifier selected from any one or a combination of polybutylene adipate-co-terephthalate (PBAT), polybutylene terephthalate (PBT), polybutylene succinate (PBS), polybutylene succinate-co-adipate (PBSA), polyhydroxyalkanoate (PHA), polycaprolactone (PCL), and a thermoplastic elastomer; and
a flame retardant.

2. The blend as claimed in claim 1 wherein the flame retardant comprises any one or a combination of:
an organohalogen; and
an organophosphate.

3. The blend as claimed in claim 1 wherein the flame retardant comprises any one or a combination of:
a mineral based material; and
ammonium polyphosphate.

4. The blend as claimed in claim 1 wherein the flame retardant comprises any one or a combination of:
aluminium diethylene phosphonate;
aluminium hydroxide;
magnesium hydroxide;
melamine polyphosphate;
dihydrooxaphosphaphenanthrene;
zinc stannate; and
zinc hydroxystannate.

5. The blend as claimed in claim 1 wherein the flame retardant is present at an amount of from 15 to 35 wt. %; based on the total weight of the blend; and/or wherein the impact strength and/or flow rate modifier is included at an amount of from 5 to 40 wt. % based on the total weight of the blend.

6. (canceled)

7. The blend as claimed in claim 1 wherein the impact strength and/or flow modifier comprises PBAT, PCL, or a polyether block amide (PEBA).

8. The blend as claimed in claim 1 further comprising a nucleating agent, optionally wherein the nucleating agent comprises any one or a combination of talc; poly-D-lactide; ethylene bis-stearamide (EBS); an aromatic sulfone derivative; an organic nucleating agent; and mineral based particles; and optionally wherein the nucleating agent is included at an amount of from 0.1 to 25 wt. % based on the total weight of the blend.

9. (canceled)

10. (canceled)

11. The blend as claimed in claim 1 further comprising a melt strength and stability modifier; optionally wherein the melt strength and stability modifier comprises an acrylic based material being an oligomeric chain extender; and optionally wherein the melt strength and stability modifier is included at an amount of from 0.1 to 5 wt. % based on the total weight of the blend.

12. (canceled)

13. (canceled)

14. The blend as claimed in claim 1 further comprising a reinforcing filler, optionally wherein the reinforcing filler comprises any one or a combination of: a mineral based filler, calcium carbonate, talc, glass fibers, a silicate, and a calcium inosilicate material, and optionally wherein the reinforcing filler is included at an amount of from 1 to 30 wt. % based on the total weight of the blend.

15. (canceled)

16. (canceled)

17. The blend as claimed in claim 1:
wherein the flame retardant comprises APP and/or a melamine; encapsulated APP; and/or
wherein the impact strength and/or flow rate modifier comprises a polyether block amide (PEBA), PBAT or PBAT and PCL.

18. The blend as claimed in claim 1 wherein the PLA is included at not less than 50 wt. %; or wherein the PLA is included at 28 to 86 wt %; based on the total weight of the blend.

19. The blend as claimed in claim 1 wherein the thermoplastic elastomer is present and selected from any one or a combination of:
a styrenic block copolymer;
a polyolefin elastomer;
a vulcanizate;
a polyurethane;
a copolyester;
a polyamide;
a polyether block amide (PEBA); and
nylon.

20. A flame retardant composition comprising:
a blend as claimed in claim 1; and
any one of or a combination of:
a filler;
a compatibilizer; and
a processing aid.

21. (canceled)

22. An article comprising the blend of claim 1, optionally wherein the article is further defined as a plug; a bottle; a container for food stuffs a packaging article; an extruded profile; a casing for an electronics device; or a laptop, electronics tablet or smartphone casing.

23. (canceled)

24. A method of manufacturing a blend, the method comprising:
preparing a material batch from starting materials comprising:
polylactic acid;
an impact strength and/or flow rate modifier selected from any one or a combination of polybutylene adipate-co-terephthalate (PBAT), polybutylene terephthalate (PBT), polybutylene succinate (PBS), polybutylene succinate-co-adipate (PBSA), polyhydroxyalkanoate (PHA), polycaprolactone (PCL), and a thermoplastic elastomer; and
a flame retardant;
heating the material batch to form a heated melt; and
cooling the heated melt to form the blend;
optionally wherein the step of heating comprises heating at a temperature in a range 150 to 230° C.; and
optionally further comprising blending the material batch prior to heating the material batch.

25. (canceled)

26. The method as claimed in claim 24 wherein:
the step of heating comprises passing the material batch through an extruder to form an extruded strand; and
the step of cooling comprises passing the extruded strand into a water bath.

27. (canceled)

28. A flame resistant blend manufactured by the method as claimed in claim 24.

29. A method of polymer processing to create a plastic product comprising the steps of processing the polymer blend of claim 1 by any one or a combination of:
extrusion;
injection moulding;
blow moulding; and
thermoforming; and
optionally annealing the plastic product or article after the step of thermoforming, moulding or extruding, optionally wherein the step of annealing comprises heating the plastic product or article at a temperature in the range 50° C. to 140° C. to induce crystallinity.

30. A method of manufacturing an article comprising:
placing the blend obtained from the method of claim 24 into a mould;
heating the mould and/or the blend; and
cooling the blend to obtain the article.

31. A method of manufacturing an article comprising:
placing the blend obtained from the method of claim 24 into an extruder;
extruding the blend through a die to form a profile; and
cooling the blend to obtain the article

32. (canceled)

33. (canceled)
